(19) United States
(12) Patent Application Publication
(10) Pub. No.: US 2017/0120562 A1
(43) Pub. Date: May 4, 2017

(54) OPTICALLY CLEAR ADHESIVES AND METHODS OF PRODUCING THE SAME

(71) Applicant: COVERIS FLEXIBLES US LLC, Chicago, IL (US)

(72) Inventors: Greg Williams, Matthews, NC (US); Jingfu Fan, Matthews, NC (US)

(21) Appl. No.: 15/317,749

(22) PCT Filed: Jun. 9, 2015
(86) PCT No.: PCT/US15/34939

§ 371 Date: Dec. 9, 2016

Related U.S. Application Data
(60) Provisional application No. 62/009,794, filed on Jun. 9, 2014.

(51) Int. Cl. B32B 7/12; B32B 27/36; B32B 27/30; B32B 27/08; B32B 27/28

(52) U.S. Cl. CPC B32B 7/12; B32B 27/08; B32B 27/283; B32B 27/308; B32B 27/36; B32B 2307/412; B32B 2405/00; B32B 2457/20

(57) ABSTRACT

This disclosure relates generally to optically clear adhesives and methods of their production. The disclosed adhesives may contain features of both optically clear adhesive films and optically clear adhesive liquids. The disclosed optically clear adhesives may be useful in the assembly processes for a variety of applications, including in the assembly of optical display elements.

### CROSS-REFERENCE TO RELATED APPLICATIONS

This patent application clams priority to U.S. Provisional Patent Application No. 621009,794 entitled OPTICALLY CLEAR ADHESIVES AND METHODS OF PRODUCING THE SAME, filed on Jun. 9, 2014, which is incorporated herein by reference in its entirety.

### TECHNICAL FIELD

Embodiments disclosed herein relate generally to optically clear adhesives and methods of their production and use. The disclosed adhesives may contain features of both optically clear adhesive films and optically clear adhesive liquids. Certain embodiments of the disclosed optically clear adhesives may be useful in the assembly processes for a variety of devices, including, without limitation, optical display elements.

### DESCRIPTION

Optically clear adhesives are widely used in electronic devices including mobile phones, televisions, tablets, watches, and those in automobile interiors, where optical clarity in display panels may be important. Such adhesives may provide benefits such as shock resistance, enhanced contrast, and improved brightness reduction. For example, in various types of devices, such as mobile phones, tablets, or computer pads, an optically clear adhesive (OCA) may be used to bond the top cover glass or film to the touch panel sensor plate. An OCA may also be used to fill the gap between the touch panel sensor plate and an LCD module.

There are currently two types of OCA products commercially available in the market: pre-coated films and liquid pastes. Commercially available examples of film OCAs include CEF 0807, CEF 0707 and CEF 08A05 from 3M Company, headquartered in Minnesota, USA. Commercially available examples of liquid paste OCAs include Loctite 3192, 3191 and 5192 from Henkel, headquartered in Dusseldorf, Germany.

The flow properties of an OCA are relevant to electronic touch panel bonding applications. In certain applications, a flowable OCA may he desirable. An OCA film which is flowable may help it conform to an uneven or rough surface, such as a surface with printed patterns inside a touch panel module. These printed patterns may have ink steps, and in some cases large ink steps, including those which may project from about 40 to about 70 microns above the surface of the glass or film substrate. In general, a liquid OCA is more flowable than a film OCA. A liquid OCA is typically cured after it is applied to optical elements.

The ease of die-cutting an OCA film is another relevant property. If an adhesive film is too soft, it may create processing difficulties which can result in a low yield for a die-cutting process. This may be especially true for an OCA with a thickness larger than about 100 microns, which is a thickness often used in optical display applications.

Disclosed herein are multi-layer OCA films and methods of making the films using web coating technologies. Such OCA films typically include a center layer and at least one outer layer. In some embodiments, the OCA films are two-layer films having an outer layer and a center layer. In other embodiments, the OCA films are three-layer films having a center layer and two outer layers. In such OCA films, the outer layers may be identical, while in others, they may be independently selected.

A schematic illustration of such a three-layer film is shown below, and is intended for illustrative purposes only. Thus, the illustration is not intended to limit the film in any manner, such as, for example, regarding the thicknesses of each layer relative to any other layer or to the entire film.

outer layer
center layer
outer layer

In some embodiments, the disclosed optically clear adhesives may combine features of both film and liquid optically clear adhesives. More specifically, certain embodiments of the disclosed optically clear adhesives may include some or all of the features discussed herein.

The OCA may have a UV-curable outer layer with a tan delta (tan δ) value larger than about 1.0, as measured by dynamic mechanical analysis (DMA). A tan delta value may be used to estimate the ease of flow of the adhesive and is often used in describing pressure sensitive adhesives. Higher tan delta values are characteristic of adhesives that have better adhesive flow (good ink-wetting) and better stress relaxation.

Generally, commercially available OCA films have a tan delta value of between about 0.4 and about 0.7, and typically under about 1.0. The outer layer or layers of the disclosed optically clear adhesives may have a tan delta value of between about 0.9 and about 3.0, but may typically be above about 1.0. The disclosed OCA films may thus have at least one outer layer with a tan delta value which is above what may be commonly available commercially.

The disclosed OCA films are typically three-layer structures with a total thickness which may be from about 100 to about 300 microns, and may be coated via a standard web coating process or a precision web coating process,

In some embodiments, the OCA films may contain a center layer which has a thickness of between about 60 and about 180 microns with a high flexural modulus. In certain embodiments, the OCA films may include two outer layers, each with a thickness of between about 20 and about 60 microns. Each layer may be sized dependently or independently of the other layers.

In some OCA films of this disclosure, outer layers may each be UV-curable and may be designed to be cured after the adhesive is applied to a substrate. In some embodiments, the tan delta values of each of the two outer layers is between about 0.9 and about 3.

In some OCA films of this disclosure, the center layer of the OCA may have a tensile modulus larger than 0.3 Mpa,

In some OCA films of this disclosure, the OCA is sandwiched between two release liners (not shown in the illustration above). In certain instances, the OCA may contain a center layer with only a single outer layer.

The OCA may be optically clear with an optical transmission greater than about 90 and a haze of less than about 5%.

In some instances, the OCAs of this disclosure may exhibit strong adhesion to glass or another substrate, with an adhesion of greater than about 4 pounds/inch based on the 180 degree peel test at a 12 in/min line speed on an Instron® machine.

In certain embodiments, an optically clear adhesive may exhibit all of the above-listed properties. Alternatively, an OCA may exhibit only one, or a subset of, the listed properties.

The center layer of the optically clear adhesive may be a cross-linked pressure sensitive adhesive. It may be cured by radiation, such as UV light or an electron beam (ES), or it may be thermally cured. Exemplary UV cured pressure sensitive adhesives include the UV curable acrylic pressure sensitive adhesives disclosed in U.S. Pat. No. 8,361,632 by Everaerts and Xia. Exemplary thermally cured pressure sensitive adhesives include commercially available pressure sensitive adhesives from Henkel and Ashland. The center layer may also contain one or more photoinitiators, cross linkers, and/or solvents.

The outer layer or layers of a multi-layer optically clear adhesive each may be a UV-curable acrylate, UV- and/or moisture-curable silicone, and may contain at least one photoinitiator. Other components of an outer layer may include peroxide, melamine, isocyanate, and/or aziridine as, for example, a cross linker(s). Still other components of an outer layer may include plasticizers, tackifiers, solvents, and/or other additives. Exemplary solvents include toluene, methyl ethyl ketone (MEK), and ethyl acetate. An exemplary cross linker is aluminum triacetate.

Examples of UV-curable acrylates suitable for use in the center layer and/or outer layer or layers are monomeric and oligomeric acrylates, including those comprising 2-ethylhexyl acrylate (EHA); an aliphatic urethane oligomer such as CN9018 from Sartomer Company in Pennsylvania, USA; an acrylic ester such as CN9021 from Sartomer; a urethane acrylate such as Genomer 4188 from RAHN USA Corp., Aurora, Ill.; and an aliphatic urethane acrylate such as Genomer 4269 from RAHN USA. Examples of photoinitiators include alpha-hydroxy ketones and phosphine oxides such as Genocure LTM and TPO from RAHN USA, and lrgacure 184 and 819 from BASF.

In certain embodiments, the optically clear adhesive may contain a layer comprising a polyester, such as a modified saturated polyester Genomer 6043/M22 from RAHN USA. In some embodiments, the optically clear adhesive may contain a layer comprising 2-(2-ethoxyethoxy)ethyl acrylate, such as SR-256 from Sartomer.

In some embodiments, the OCA or a layer of the OCA may be coated from a pre-cured premixture. This may aid in the coating of a substrate to generate a defect-free, or substantially defect-free coating.

In some embodiments, the mixture may have a viscosity of about 2000 cps, which may be useful for coating a substrate via a slot-die method. Other coating methods could also be used. Other similarly suitable components may be known to one of skill in the art.

Methods of using the OCA films are also disclosed herein. In particular, it is contemplated that any of the components, principles, and/or embodiments discussed above may be utilized in either an OCA film or a method of using the same. For example, in an embodiment, a method can include use of the OCA films in bonding two or more surfaces. In another embodiment, a method can include use of the OCA films in bonding a first surface such as a top cover glass or film to a second surface such as a touch panel sensor plate. Additional steps and/or methods can also be employed.

### EXAMPLES

The specific examples included herein are for illustrative purposes only and are not to be considered as limiting to this disclosure. The components used in the following examples are either commercially available or can be prepared according to standard literature procedures by those skilled in the art. In light of this disclosure, those of skill in the art will recognize that variations of these examples and other examples of the disclosed methods would be possible without undue experimentation.

The following is a sample formulation for the center layer of an exemplary embodiment of an optically clear adhesive:

| | | percentage of the |
|---|---|---|
| | specific example of a | component by weight of |
| component type | component | the layer |
| urethane acrylate/2- | Genomer 4188/EHA | from about 10% to about |
| ethylhexyl acrylate | | 20% |
| polyester resin | Genomer 6043/M22 | from about 50% to about |
| | | 60% |
| acrylate resin | SR-256 | from about 20% to about |
| | | 30% |
| photoinitiator | Genocure LTM | from about 2% to about |
| | | 5% |

The following is a sample formulation for the center layer of an additional exemplary embodiment of an optically clear adhesive:

| | | percentage of the |
|---|---|---|
| | specific example of a | component by weight of |
| component type | component | the layer |
| pressure sensitive | Durotak 230A | from about 50% to about |
| adhesive | | 100% |
| cross linker | Al(Ac)₃ | from about 0 to about 10% |
| solvent | Toluene | from about 0 to about 50% |
| solvent | Ethyl acetate | from about 0 to about 50% |

The following is a sample formulation for an outer layer or layers of an exemplary embodiment of an optically clear adhesive:

| | | percentage of the |
|---|---|---|
| | specific example of a | component by weight of |
| component type | component | the layer |
| urethane acrylate/2- | Genomer 4188/EHA | from about 50% to about |
| ethylhexyl acrylate | | 100% |
| solvent | MEK | from about 0 to about 50% |
| solvent | Toluene | from about 0 to about 50% |
| photoinitiator | Genomer TPO | from about 0 to about 10% |
| photoinitiator | Irgacure 184 | from about 0 to about 10% |

References cited throughout this disclosure, including patents, are herein incorporated by reference in theft entirety.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

1. A multi-layer optically clear adhesive film, comprising:
a center layer comprising a cross-linked pressure sensitive adhesive; and
a first outer layer comprising at least one of a UV-curable acrylate, a UV-curable silicone, or a moisture-curable silicone.

2. The multi-layer optically clear adhesive film of claim 1, further comprising:
a second outer layer comprising at least one of a UV-curable acrylate, a UV-curable silicone, or a moisture-curable silicone, wherein the first outer layer is disposed on a first side of the center layer and the second outer layer is disposed on a second side of the center layer.

3. The multi-layer optically clear adhesive film of claim 1, wherein the thickness of the film is between about 100 and about 300 microns.

4. The multi-layer optically clear adhesive film of claim 1, wherein the thickness of the center layer is between about 60 and about 180 microns.

5. The multi-layer optically clear adhesive film of claim 1, wherein the thickness of the first outer layer is between about 20 and about 60 microns.

6. The multi-layer optically clear adhesive film of claim 1, wherein the first outer layer has a tan delta value of between about 0.9 and about 3.0.

7. The multi-layer optically clear adhesive film of claim 1, wherein the film has an optical transmission value of greater than about 90.

8. The multi-layer optically clear adhesive film of claim 1, wherein the film has a haze value of less than about 15%.

9. The multi-layer optically clear adhesive film of claim 1, wherein the film comprises an adhesion value of greater than about 4 pounds per inch based on a 180 degree peel test at 12 in/min line speed.

10. The multi-layer optically clear adhesive film of claim 1, wherein the center layer comprises a tensile modulus greater than 0.3 Mpa.

11. The multi-layer optically clear adhesive film of claim 1, wherein the center layer comprises a UV curable pressure sensitive adhesive or a thermally curable pressure sensitive adhesive.

12. The multi-layer optically clear adhesive film of claim 1, wherein the first outer layer further comprises a photoinitator.

13. The multi-layer optically clear adhesive film of claim 1, wherein the first outer layer further comprises peroxide, melamine, isocyanate, or aziridine.

14. The multi-layer optically clear adhesive film of claim 1, wherein the first outer layer comprises a UV-curable acrylate selected from at least one of a monomeric acrylate, an oligomeric acrylate, an aliphatic urethane oligomer, an acrylic ester, a urethane acrylate, or an aliphatic urethane acrylate.

15. The multi-layer optically clear adhesive film of claim 1, wherein at least one of the first outer layer and center layer comprises 2-ethylhexyl acrylate.

16. The multi-layer optically clear adhesive film of claim 1, wherein at least one of the first outer layer and center layer comprises a polyester.

17. The multi-layer optically clear adhesive film of claim 1, wherein at least one of the first outer layer and center layer comprises 2-(2-ethoxyethoxy)ethyl acrylate.

18. The multi-layer optically clear adhesive film of claim 1, wherein the center layer further comprises a photoinitiator.

19. A multi-layer optically clear adhesive film, comprising:
a center layer comprising a cross-linked pressure sensitive adhesive;
a first outer layer comprising at least one of a UV-curable acrylate, a UV-curable silicone, or a moisture-curable silicone; and
a second outer layer comprising at least one of a UV-curable acrylate, a UV-curable silicone, or a moisture-curable silicone, wherein the first outer layer is disposed on a first side of the center layer and the second outer layer is disposed on a second side of the center layer;
wherein the film has an optical transmission value of greater than about 90.

20. The multi-layer optically clear adhesive film of claim 19, wherein the film has a haze value of less than about 15%.
